(19) United States
(12) Patent Application Publication
(10) Pub. No.: US 2024/0349350 A1
(43) Pub. Date: Oct. 17, 2024

(54) RANDOM ACCESS METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(21) Appl. No.: 18/579,185

(22) PCT Filed: Jul. 14, 2021
(86) PCT No.: PCT/CN2021/106308

§ 371 Date: Jan. 12, 2024

(51) Int. Cl. H04W 74/0833

(52) U.S. Cl. CPC H04W 74/0833

(57) ABSTRACT

A method for random access is performed by a terminal, and includes: determining random access resource configuration information, wherein the random access resource configuration information is configured to indicate a plurality of initial uplink bandwidth parts, and wherein each initial uplink bandwidth part of the plurality of initial uplink bandwidth parts comprises a physical random access channel (PRACH) resource; and performing random access based on the random access resource configuration information.

### CROSS-REFERENCE TO RELATED APPLICATIONS

The present application is a U.S. National phase application of International Application No. PCT/CN2021/106308, filed on Jul. 14, 2021, the entire content of which is incorporated herein by reference.

### TECHNICAL FIELD

The present disclosure relates to the field of communication technologies, and in particular, to a random access method, apparatus and storage medium.

### BACKGROUND

With the continuous development of the Internet of Things (IoT) services, e.g., the popularity of services such as video surveillance, smart home, wearable devices and industrial sensing and monitoring, these services usually require rates of tens to 100 M, and also have relatively high requirements on delay, so it is difficult for the technologies of Machine Type Communication (MTC) and Narrow band Internet of things (NB-IoT) in the related art to meet the requirements. Therefore, it is proposed to design a new type of terminal in 5G New Radio (NR) to cover the requirements of mid-range IoT devices. In the current 3GPP standardization, this new type of terminal is called Reduced capability UE, or abbreviated as NR-lite or Redcap terminal.

With the introduction of Redcap terminals, the capabilities of terminals have been differentiated. For example, Redcap terminals are limited in sending and receiving bandwidth compared to normal terminals (normal UEs). Therefore, differentiated bandwidth configuration is needed for Redcap terminals, and how to configure random access resources is a research topic for Redcap terminals configured with differentiated bandwidth.

### SUMMARY

According to a first aspect of the present disclosure, there is provided a method for random access, performed by a terminal, the method including:
determining random access resource configuration information, where the random access resource configuration information is configured to indicate a plurality of initial uplink bandwidth parts, and each initial uplink bandwidth part of the plurality of initial uplink bandwidth parts includes a physical random access channel (PRACH) resource; and performing random access based on the random access resource configuration information.

According to a second aspect of the present disclosure, there is provided a method for random access, performed by a network device, the method including:
determining random access resource configuration information, where the random access resource configuration information is configured to indicate a plurality of initial uplink bandwidth parts, and each initial uplink bandwidth part of the plurality of initial uplink bandwidth parts includes a physical random access channel (PRACH) resource; and sending the random access resource configuration information.

According to a third aspect of the present disclosure, there is provided a device for random access, including:
a processor; and a memory configured to store instructions executable by the processor;
where the processor is configured to perform the random access method described in the first aspect.

According to a fourth aspect of the present disclosure, there is provided a device for random access, including:
a processor; and
a memory configured to store instructions executable by the processor;
where the processor is configured to perform the random access method described in the second aspect.

According to a fifth aspect of the present disclosure, there is provided a non-transitory storage medium, storing instructions that, when executed by a processor of a terminal, cause the terminal to perform the random access method described in the first aspect.

According to a sixth aspect of the present disclosure, there is provided a non-transitory storage medium, storing instructions that, when executed by a processor of a network device, cause the network device to perform the random access method described in the second aspect.

It is to be understood that the above general description and the following detailed description are exemplary and explanatory only and do not limit the present disclosure.

### BRIEF DESCRIPTION OF THE DRAWINGS

The accompanying drawings herein are incorporated into and form a part of the specification, illustrate embodiments consistent with the present disclosure, and are used in conjunction with the specification to explain the principles of the present disclosure.

FIG. 1 is a schematic diagram of a wireless communication system illustrated according to an embodiment.

FIG. 2 is a flowchart of a random access method illustrated according to an embodiment.

FIG. 3 is a schematic diagram of a plurality of Initial UL BWPs configured for a RedCap terminal on unlicensed spectrum, illustrated according to an embodiment.

FIG. 4 is a flowchart of a random access method illustrated according to an embodiment.

FIG. 5 is a flowchart of a random access method illustrated according to an embodiment.

FIG. 6 is a flowchart of a random access method illustrated according to an embodiment.

FIG. 7 is a flowchart of a random access method illustrated according to an embodiment.

FIG. 8 is a flowchart of a random access method illustrated according to an embodiment.

FIG. 9 is a block diagram of a random access apparatus illustrated according to an embodiment.

FIG. 10 is a block diagram of a random access apparatus illustrated according to an embodiment.

FIG. 11 is a block diagram of a device for random access illustrated according to an embodiment.

FIG. 12 is a block diagram of a device for random access illustrated according to an embodiment.

### DETAILED DESCRIPTION

Embodiments will be described herein in detail, examples of which are represented in the accompanying drawings. When the following description relates to the accompanying drawings, the same numerals in the different accompanying drawings indicate the same or similar elements unless otherwise indicated. The embodiments described below do not represent all embodiments consistent with the present disclosure. Rather, they are only examples of devices and methods consistent with some aspects of the present disclosure as detailed in the appended claims.

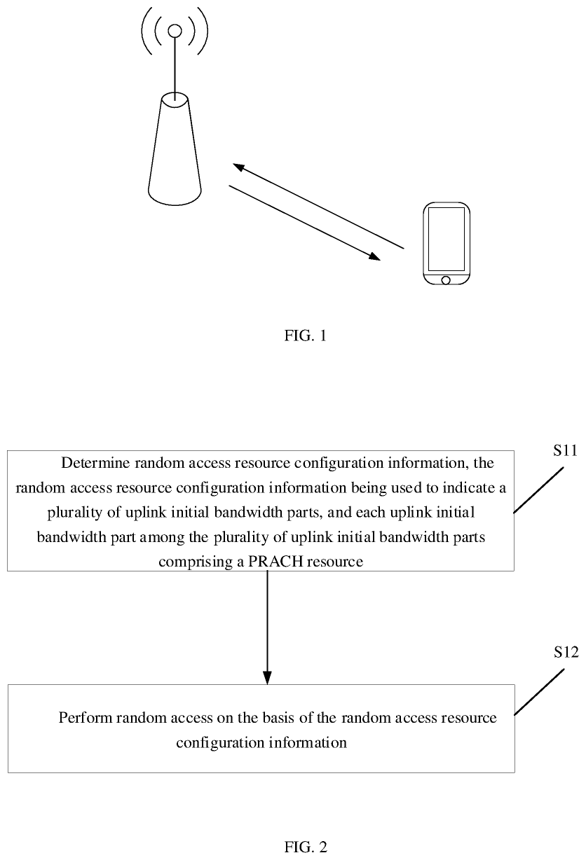

The access method provided by embodiments of the present disclosure may be applied in a wireless communication system shown in FIG. 1. Referring to FIG. 1, a terminal and a network device are included in the wireless communication system. Information is sent and received between the terminal and the network device via wireless resources.

It is to be understood that the wireless communication system shown in FIG. 1 is for schematic illustration only, and other network devices may be included in the wireless communication system, for example, core network devices, wireless relay devices, and wireless backhaul devices, etc., which are not shown in FIG. 1, may also be included. The embodiments of the present disclosure do not limit the number of network devices and the number of terminals included in the wireless communication system.

It is further to be understood that the wireless communication system of the embodiments of the present disclosure is a network that provides wireless communication functions. The wireless communication system may use different communication technologies, such as code division multiple access (CDMA), wideband code division multiple access (WCDMA), time division multiple access (TDMA), frequency division multiple access (FDMA), orthogonal frequency-division multiple access (OFDMA), single Carrier FDMA (SC-FDMA), and Carrier Sense Multiple Access with Collision Avoidance. Different networks can be categorized as a 2 generation (2G) network, a 3G networks, a 4G networks, or a future evolved network such as a 5G network which can also be referred to as a New Radio (NR) network, based on their capacity, rate, latency, and other factors. For ease of description, in some parts of this disclosure, the wireless communication network will be referred to as a network for short.

Further, the network device involved in the present disclosure may also be referred to as a wireless access network device. The wireless access network device may be a base station, an evolved node B (base station), a home base station, an access point (AP) in a wireless fidelity (WIFI) system, a wireless relay node, a wireless backhaul node, a transmission point (TP), or a transmission and reception point (TRP), and the like, or it may be a gNB in a NR system, or, alternatively, it may be a component or part of a device that constitutes a base station. When the network is a vehicle to everything (V2X) communication system, the network device may also be a vehicle device. It is to be understood that the embodiments of the present disclosure do not limit the specific technology and the specific device form used for the network device.

Further, the terminal involved in the present disclosure, which may also be referred to as a terminal device, user equipment (UE), mobile station (MS), mobile terminal (MT), etc., is a device that provides voice and/or data connectivity to a user, e.g., the terminal may be a handheld device, a vehicle device, etc., having a wireless connectivity. Currently, the terminal may be, for example, a mobile phone, a pocket personal computer (PPC), a handheld computer, a personal digital assistant (PDA), a laptop computer, a tablet computer, a wearable device, or a vehicle device, etc. In addition, when the network is a vehicle to everything (V2X) communication system, the terminal device may also be a vehicle device. It is to be understood that the embodiments of the present disclosure do not limit the specific technology and the specific device form used for the terminal.

The terminal involved in the embodiments of the present disclosure may be understood as a new type of terminal designed in 5G NR, i.e., Reduced capability UE or abbreviated as NR-lite. In the embodiments of the present disclosure, this new terminal is referred to as a Redcap terminal.

Similar to Internet of Thing (IoT) devices in Long Term Evolution (LTE), the Redcap terminals typically need to fulfill the following requirements:
Low cost and low complexity.
Some degree of coverage enhancement.
Power saving.

Since the current NR system is designed for high-end terminals such as high-speed and low-latency terminals, the current design cannot meet the above requirements of Redcap terminals. Therefore, the current NR system needs to be improved to meet the requirements of NR-lite. For example, in order to meet the requirements such as low cost and low complexity, the radio frequency (RF) bandwidth of NR-IoT may be limited, such as to 5 M Hz or 10 M Hz, or, alternatively, the buffer size of NR-lite may be limited to further limit the size of the transmission block received each time. For power saving, possible optimization directions are to simplify the communication process, reduce the number of times the NR-lite terminal detects the downlink control channel, and so on.

In the related art, the RedCap terminals currently discussed operate in the licensed spectrum. However, industrial sensors, etc. are mainly used in the industrial field where unlicensed spectrum is mainly used. Therefore, RedCap terminals operating in unlicensed spectrum should also be considered.

In the unlicensed spectrum, channel monitoring is based on the listen before talk (LBT) mechanism. That is, devices that operate in the unlicensed spectrum need to monitor the channel before performing transmission, and the data can be transmitted only when the monitored channel is idle. In the NR system, channel monitoring is performed in units of LBT sub-bands. The width of an LBT sub-band is 20 MHz. When the device monitors an LBT sub-band and finds that the sub-band is busy, the device cannot send data on that sub-band. In the current NR system, a bandwidth part (BWP) monitored by the device may contain multiple LBT sub-bands. When some of the LBT sub-bands are busy, the device can operate on the other idle LBT sub-bands to avoid being unable to send and receive for a long time.

However, the Redcap terminal operating in the licensed spectrum has limited bandwidth capability, and the bandwidth of its configured initial uplink bandwidth part (Initial UL BWP) can only be within the terminal's bandwidth range, and can only contain one LBT sub-band under Frequency range 1 (FR1). However, under unlicensed spectrum, compared with large bandwidth configuration, the Initial UL BWP of the RedCap terminal in narrow-bandwidth situations is easily occupied, resulting in terminal access failure.

In view of the above, the embodiments of the present disclosure provide a random access method in which a new Initial UL BWP configuration is applied to configure a plurality of Initial UL BWPs, with each Initial UL BWP in the plurality of Initial UL BWPs including a PRACH resource, to improve the situation in which an Initial UL BWP is easily occupied resulting in a terminal access failure, and increase the possibility of access to a cell by the Redcap terminal.

FIG. 2 is a flowchart of a random access method illustrated according to an embodiment. As shown in FIG. 2, the random access method is applied to a terminal, where the terminal may be a RedCap terminal, and the method includes the following steps S11 and S12.

Step S11, determining random access resource configuration information.

The random access resource configuration information is used to indicate a plurality of Initial UL BWPs, and each Initial UL BWP in the plurality of Initial UL BWPs includes a Physical Random Access Channel (PRACH) resource.

Step S12, performing random access based on the random access resource configuration information.

In this embodiment of the present disclosure, the plurality of Initial UL BWPs may be configured for the RedCap terminal on unlicensed spectrum, and each Initial UL BWP must contain the PRACH resource(s). There may be multiple PRACH resources included in each Initial UL BWP.

In this embodiment of the present disclosure, the terminal performs random access on the unlicensed spectrum based on the plurality of Initial UL BWPs that include the PRACH resources. In this way, the cell access failure caused by a certain PRACH resource always being occupied (blocked) can be avoided, and thus increasing the possibility of the RedCap terminal to access the cell.

The embodiments of the present disclosure are described below for the plurality of Initial UL BWPs configured for the RedCap terminal on the unlicensed spectrum.

In an embodiment, the plurality of Initial UL BWPs configured for the RedCap terminal on the unlicensed spectrum are provided with different frequency domain positions, i.e., the plurality of Initial UL BWPs do not overlap in the frequency domain.

In an embodiment, the plurality of Initial UL BWPs configured for the RedCap terminal on the unlicensed spectrum may be provided with at least partially identical configurations, i.e., part of configuration information of the plurality of Initial UL BWPs is the same, in addition to different frequency domain positions. For example, the subcarrier spacing (SCS) of the plurality of Initial UL BWPs may be the same.

In yet another embodiment, PRACH resources included in respective Initial UL BWPs of the plurality of Initial UL BWPs are provided with different time domain positions. That is, the PRACH resources included in the plurality of Initial UL BWPs have different time configurations.

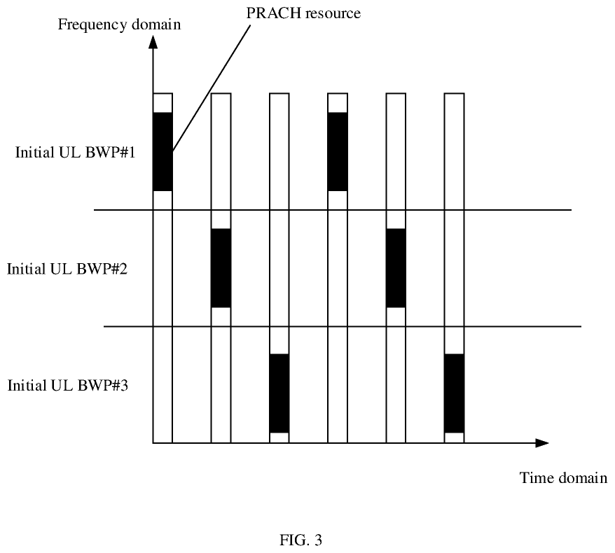

FIG. 3 is a schematic diagram of a plurality of Initial UL BWPs configured for the RedCap terminal on the unlicensed spectrum, illustrated according to an embodiment. As shown in FIG. 3, Initial UL BWP #1, Initial UL BWP #2, and Initial UL BWP #3 do not overlap in the frequency domain, and each Initial UL BWP contains PRACH resources. For example, each Initial UL BWP contains two PRACH resources. The time configuration of each PRACH resource contained in the plurality of Initial UL BWPs is different. It is to be understood that the Initial UL BWPs described above are for illustrative purposes only and do not limit the present disclosure. For example, the terminal may be configured with more Initial UL BWPs, and each Initial UL BWP contains more PRACH resources.

In this embodiment of the present disclosure, the plurality of Initial UL BWPs may be configured in Remaining Minimum System Information (RMSI) or determined based on a predefined rule.

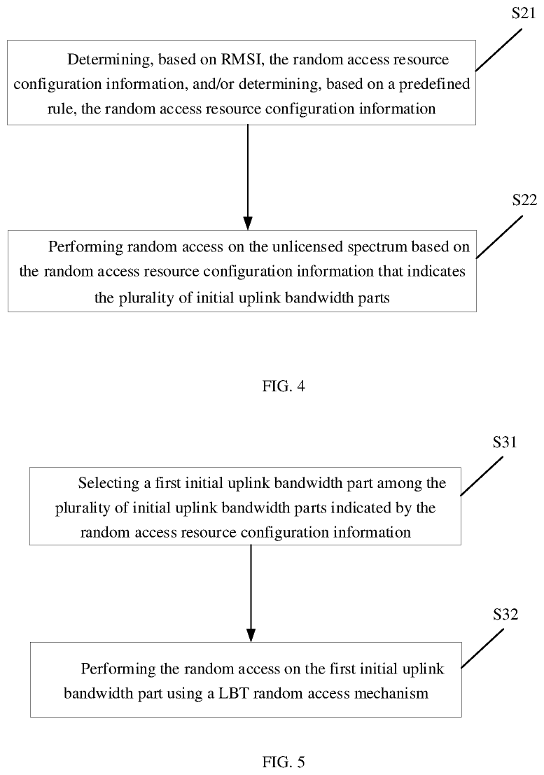

FIG. 4 is a flowchart of a random access method illustrated according to an embodiment. As shown in FIG. 4, the random access method is applied to a terminal, where the terminal may be a RedCap terminal, and the method includes the following steps S21 and S22.

Step S21, determining, based on RMSI, the random access resource configuration information, and/or determining, based on a predefined rule, the random access resource configuration information.

In an embodiment, in response to that part of configuration information of the plurality of Initial UL BWPs is the same, the same configuration information may be determined based on the RMSI of a single reception to determine the same configuration information in the plurality of Initial UL BWPs. That is, the same configuration parameter(s) may be transmitted only once in the RMSI, instead of transmitting the configuration parameter(s) of each Initial UL BWP separately in the RMSI.

In an embodiment, when determining the random access resource configuration information based on the predefined rule, the random access resource configuration information may be determined based on predefined parameters such as the existing Initial UL BWP configuration parameter(s) and the number of Initial UL BWPs.

The existing Initial UL BWP configuration parameter(s) may be, on the one hand, the Initial UL BWP configuration parameter(s) configured by RMSI in the conventional technology, such as one Initial UL BWP configured in the conventional technology, or the Initial UL BWP configuration parameter(s) configured by using the newly provided Initial UL BWP configuration method in the embodiments of the present disclosure, such as a starting position, bandwidth, etc. corresponding to each of the plurality of Initial UL BWPs.

In an example, it is possible to predefine the terminal to have, for example, N Initial UL BWPs on the basis of configuring one Initial UL BWP for the terminal via the RMSI, where the bandwidths of the remaining Initial UL BWPs are the same as that of the first Initial UL BWP, e.g., BW. Accordingly, the starting position of the frequency of the subsequent Initial UL BWPs is F0+i*BW (i=1, 2 . . . . N−1), where F0 is the starting position of the frequency of the first Initial UL BWP.

Step S22, performing random access on the unlicensed spectrum based on the random access resource configuration information that indicates the plurality of Initial UL BWPs.

In this embodiment of the present disclosure, when performing random access based on the random access resource configuration information that indicates the plurality of Initial UL BWPs, the terminal may first select an Initial UL BWP for random access.

FIG. 5 is a flowchart of a random access method illustrated according to an embodiment. As shown in FIG. 5, the random access method is applied to a terminal, where the terminal may be a RedCap terminal, and the method includes the following steps S31 and S32.

Step S31, selecting a first Initial UL BWP among the plurality of Initial UL BWPs indicated by the random access resource configuration information.

In this embodiment of the present disclosure, the first Initial UL BWP may be randomly selected among the plurality of Initial UL BWPs indicated by the random access resource configuration information, or, alternatively, the first Initial UL BWP may be selected among the plurality of Initial UL BWPs indicated by the random access resource configuration information based on a preset rule. For example, the network device notifies the terminal of the order of use of the Initial UL BWPs, or the terminal selects the Initial UL BWP to be used based on an identification number of the terminal.

Step S32, performing the random access on the first Initial UL BWP using a LBT random access mechanism.

In this embodiment of the present disclosure, when the LBT failure on one Initial UL BWP reaches a certain threshold, it can be switched to another Initial UL BWP for random access.

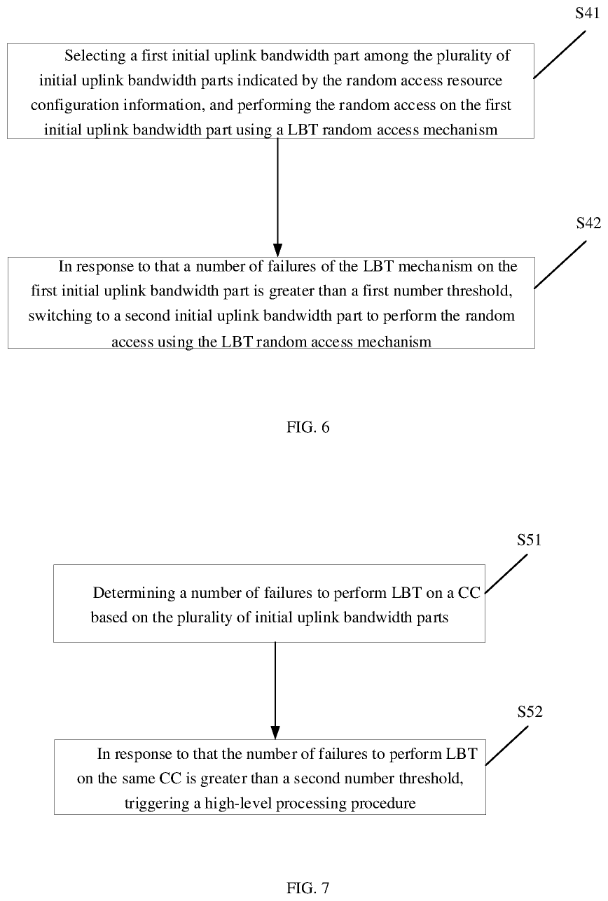

FIG. 6 is a flowchart of a random access method illustrated according to an embodiment. As shown in FIG. 6, the random access method is applied to a terminal, where the terminal may be a RedCap terminal, and the method includes the following steps S41 and S42.

Step S41, selecting a first Initial UL BWP among the plurality of Initial UL BWPs indicated by the random access resource configuration information, and performing the random access on the first Initial UL BWP using a LBT random access mechanism.

Step S42, in response to that a number of failures of the LBT mechanism on the first Initial UL BWP is greater than a first number threshold, switching to a second Initial UL BWP to perform the random access using the LBT random access mechanism.

The first number threshold may be determined based on time of continuous failures of the LBT mechanism, or the first number threshold may be determined based on a number of continuous failures of the LBT mechanism.

In the random access method provided by embodiments of the present disclosure, a high-level processing procedure may be triggered when the number of failures to perform LBT on a Component Carrier (CC) unit reaches a certain threshold.

FIG. 7 is a flowchart of a random access method illustrated according to an embodiment. As shown in FIG. 7, the random access method is applied to a terminal, where the terminal may be a RedCap terminal, and the method includes the following steps S51 and S52.

Step S51, determining a number of failures to perform LBT on a CC based on the plurality of Initial UL BWPs.

Step S52, in response to that the number of failures to perform LBT on the same CC is greater than a second number threshold, triggering a high-level processing procedure.

The second number threshold may be predefined.

In an example, when the failures of the LBT on a CC reach the second number threshold, a corresponding high-level processing procedure is triggered. For example, the terminal determines whether the access failed.

In the random access method provided by embodiments of the present disclosure, a plurality of Initial UL BWPs are configured, and each Initial UL BWP of the plurality of Initial UL BWPs includes a PRACH resource, thereby improving the situation in which an Initial UL BWP is easily occupied resulting in a terminal access failure, and increasing the possibility of access to a cell by the terminal.

Based on the same concept, the embodiments of the present disclosure further provide a random access method applied to a network device.

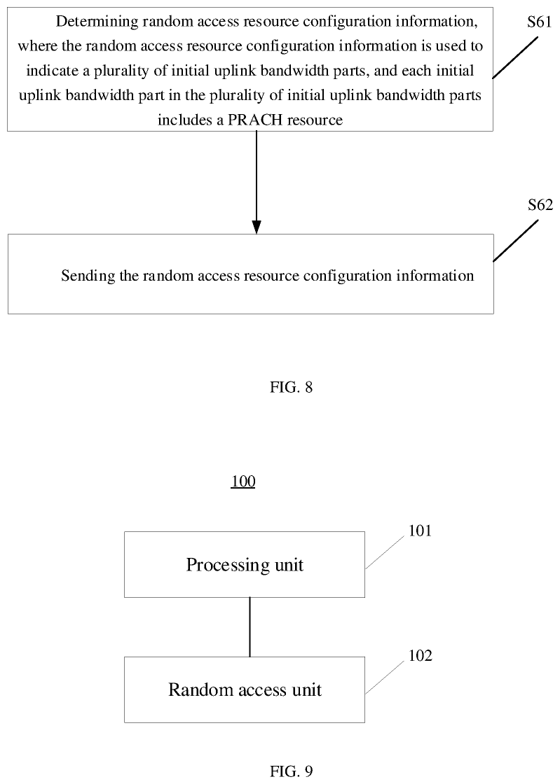

FIG. 8 is a flowchart of a random access method illustrated according to an embodiment. As shown in FIG. 8, the random access method is applied to a network device and includes the following steps S61 and S62.

Step S61, determining random access resource configuration information.

The random access resource configuration information is used to indicate a plurality of Initial UL BWPs, and each Initial UL BWP in the plurality of Initial UL BWPs includes a PRACH resource.

Step S62, sending the random access resource configuration information.

In an embodiment, the plurality of Initial UL BWPs configured for the RedCap terminal on the unlicensed spectrum are provided with different frequency domain positions, i.e., the plurality of Initial UL BWPs do not overlap in the frequency domain.

In an embodiment, the plurality of Initial UL BWPs configured for the RedCap terminal on the unlicensed spectrum may be provided with at least partially identical configurations, i.e., part of configuration information of the plurality of Initial UL BWPs is the same, in addition to different frequency domain positions. For example, the subcarrier spacing (SCS) of the plurality of Initial UL BWPs may be the same.

In yet another embodiment, PRACH resources included in respective Initial UL BWPs of the plurality of Initial UL BWPs are provided with different time domain positions. That is, the PRACH resources included in the plurality of Initial UL BWPs have different time configurations.

In this embodiment of the present disclosure, the network device may send the random access resource configuration information based on the RMSI.

In an embodiment, in response to that part of configuration information of the plurality of initial uplink bandwidth parts is the same, the same configuration information is sent based on a single transmission of the RMSI.

Based on the above embodiments, a plurality of Initial UL BWPs are configured for the RedCap terminal on the unlicensed spectrum, and each Initial UL BWP in the plurality of Initial UL BWPs includes the PRACH resource, which can improve the situation in which an Initial UL BWP is easily occupied resulting in a terminal access failure, and increase the possibility of access to a cell by the terminal.

It is to be understood that the random access method provided by the embodiments of the present disclosure is also applicable to a process in which a terminal interacts with a network device to realize random access. For the process in which the terminal interacts with the network device to realize the random access, the terminal and the network device each have the functions involved in the above embodiments, which can be referred to the relevant descriptions of the above embodiments, and will not be described in detail herein.

It is to be noted that it can be understood by those skilled in the art that the various implementations/examples involved above in the embodiments of the present disclosure may be used in conjunction with the foregoing embodiments or may be used independently. Whether they are used alone or together with the foregoing embodiments, the realization principles are similar. Some of the embodiments of the present disclosure are illustrated in embodiments used together. Of course, those skilled in the art can understand that such illustrations do not limit the embodiments of the present disclosure.

Based on the same concept, the embodiments of the present disclosure further provide a random access apparatus.

It is to be understood that the random access apparatus provided by the embodiments of the present disclosure, in order to realize the above functions, includes a hardware structure and/or a software module corresponding to the execution of the respective functions. In combination with the units and algorithmic steps of the various examples disclosed in the embodiments of the present disclosure, the embodiments of the present disclosure are capable of being realized in the form of hardware or a combination of hardware and computer software. Whether a particular function is performed as hardware or computer software driving hardware depends on the particular application and design constraints of the technical solution. Those skilled in the art may use a different approach for each particular application to implement the described functionality, but such implementation should not be considered beyond the scope of the technical solutions of the embodiments of the present disclosure.

FIG. 9 is a block diagram of a random access apparatus illustrated according to an embodiment. Referring to FIG. 9, the random access apparatus 100 is applied to a terminal, and the random access device 100 includes a processing unit 101 and a random access unit 102.

The processing unit 101 is configured to determine random access resource configuration information, where the random access resource configuration information is configured to indicate a plurality of Initial UL BWPs, and each Initial UL BWP of the plurality of Initial UL BWPs includes a physical random access channel (PRACH) resource. The random access unit 102 is configured to perform random access based on the random access resource configuration information.

In an embodiment, the plurality of Initial UL BWPs are provided with different frequency domain positions.

In an embodiment, part of configuration information of the plurality of Initial UL BWPs is the same.

In an embodiment, PRACH resources included in respective Initial UL BWPs of the plurality of Initial UL BWPs are provided with different time domain positions.

In an embodiment, the processing unit 101 is configured to determine, based on RMSI, the random access resource configuration information, and/or to determine, based on a predefined rule, the random access resource configuration information.

In an embodiment, the processing unit 101 is configured to determine, in response to that part of configuration information of the plurality of Initial UL BWPs is the same, the same configuration information based on the RMSI of a single reception.

In an embodiment, the random access unit 102 is configured to select a first Initial UL BWP among the plurality of Initial UL BWPs indicated by the random access resource configuration information, and to perform the random access on the first Initial UL BWP using a LBT random access mechanism.

In an embodiment, the random access unit 102 is configured to randomly select the first Initial UL BWP among the plurality of Initial UL BWPs indicated by the random access resource configuration information; or the random access unit 102 is configured to select, based on a preset rule, the first Initial UL BWP among the plurality of Initial UL BWPs indicated by the random access resource configuration information.

In an embodiment, in response to that a number of failures of the LBT mechanism on the first Initial UL BWP is greater than a first number threshold, the random access unit 102 is configured to switch to a second Initial UL BWP to perform the random access using the LBT random access mechanism.

In an embodiment, the first number threshold is determined based on time of continuous failures of the LBT mechanism, or a number of continuous failures of the LBT mechanism.

In an embodiment, the processing unit 101 is further configured to trigger a high-level processing procedure in response to that a number of failures of the LBT mechanism on a same CC is greater than a second number threshold.

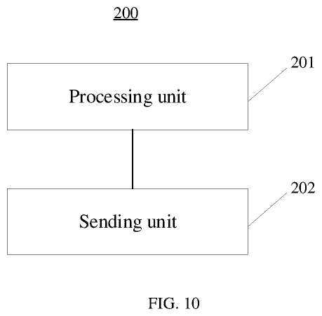

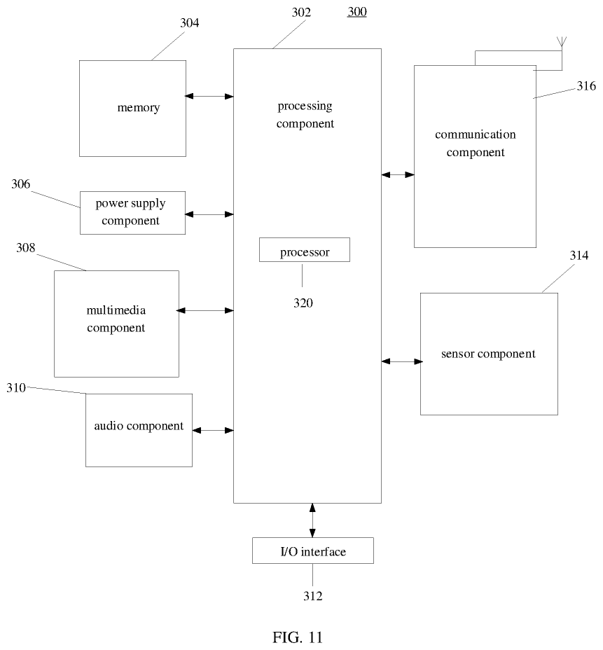

FIG. 10 is a block diagram of a random access apparatus illustrated according to an embodiment. Referring to FIG. 10, the random access apparatus 200 is applied to a network device, and the random access apparatus 200 includes a processing unit 201 and a sending unit 202.

The processing unit 201 is configured to determine random access resource configuration information, where the random access resource configuration information is configured to indicate a plurality of Initial UL BWPs, and each Initial UL BWP of the plurality of Initial UL BWPs includes a physical random access channel (PRACH) resource. The sending unit 202 is configured to send the random access resource configuration information.

In an embodiment, the plurality of Initial UL BWPs are provided with different frequency domain positions.

In an embodiment, part of configuration information of the plurality of Initial UL BWPs is the same.

In an embodiment, PRACH resources included in respective Initial UL BWPs of the plurality of Initial UL BWPs are provided with different time domain positions.

In an embodiment, the sending unit 202 is configured to send the random access resource configuration information based on RMSI.

In an embodiment, the sending unit 202 is configured to send, in response to that part of configuration information of the plurality of Initial UL BWPs is the same, the same configuration information based on a single transmission of the RMSI.

With regard to the apparatus in the above embodiments, the specific manner in which each module performs an operation has been described in detail in the embodiments relating to the method, and will not be described in detail herein.

FIG. 11 is a block diagram of a device for random access illustrated according to an embodiment. For example, the device 300 may be a cell phone, a computer, a digital broadcast terminal, a message transceiver device, a game console, a tablet device, a medical device, a fitness device, a personal digital assistant, and the like.

Referring to FIG. 11, the device 300 may include one or more of the following components: a processing component 302, a memory 304, a power supply component 306, a multimedia component 308, an audio component 310, an input/output (I/O) interface 312, a sensor component 314, and a communication component 316.

The processing component 302 generally controls the overall operation of the device 300, such as operations associated with displays, telephone calls, data communications, camera operations, and recording operations. The processing component 302 may include one or more processors 320 to execute instructions to accomplish all or some of the steps of the methods described above. In addition, the processing component 302 may include one or more modules to facilitate interaction between the processing component 302 and other components. For example, the processing component 302 may include a multimedia module to facilitate interaction between the multimedia component 308 and the processing component 302.

The memory 304 is configured to store various types of data to support operation at the device 300. Examples of such data include instructions for any application or method operated on the device 300, contact data, phone book data, messages, pictures, videos, etc. The memory 304 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, Disk or CD-ROM.

The power supply component 306 provides power to various components of the device 300. The power supply component 306 may include a power management system, one or more power sources, and other components associated with generating, managing, and distributing power for the device 300.

The multimedia component 308 includes a screen providing an output interface between the device 300 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes and gestures on the touch panel. The touch sensors may not only sense the boundaries of the touch or swipe action, but also detect the duration and pressure associated with said touch or swipe operation. In some embodiments, the multimedia component 308 includes a front camera and/or a rear camera. The front camera and/or the rear camera may receive external multimedia data when the device 300 is in an operational mode, such as a shooting mode or a video mode. Each front camera and rear camera may be a fixed optical lens system or have a focal length and optical zoom capability.

The audio component 310 is configured to output and/or input audio signals. For example, the audio component 310 includes a microphone (MIC) configured to receive external audio signals when the device 300 is in an operational mode, such as a call mode, a recording mode, and a voice recognition mode. The received audio signals may be further stored in memory 304 or sent via communication component 316. In some embodiments, the audio component 310 further includes a speaker for outputting audio signals.

The I/O interface 312 provides an interface between the processing component 302 and a peripheral interface module, and the peripheral interface module may be a keypad, a click wheel, a button, and the like. These buttons may include, but are not limited to: a home button, a volume button, a start button, and a lock button.

The sensor component 314 includes one or more sensors for providing an assessment of various aspects of the status of the device 300. For example, the sensor component 314 may detect an open/closed state of the device 300, the relative positioning of components, such as the components being the display and keypad of the device 300, and the sensor component 314 may also detect a change in the position of the device 300 or of one of the components of the device 300, the presence or absence of user contact with the device 300, the orientation or acceleration/deceleration of the device 300 and a change in temperature of the device 300. The sensor component 314 may also include a proximity sensor configured to detect the presence of a nearby object in the absence of any physical contact. The sensor component 314 may also include a light sensor, such as a CMOS or CCD image sensor, for use in imaging applications. In some embodiments, the sensor component 314 may also include an acceleration sensor, a gyroscope sensor, a magnetic sensor, a pressure sensor, or a temperature sensor.

The communication component 316 is configured to facilitate communication between the device 300 and other devices by wired or wireless means. The device 300 may access a wireless network based on a communication standard, such as Wi-Fi, 2G or 3G or a combination thereof. In an embodiment, the communication component 316 receives broadcast signals or broadcast-related information from an external broadcast management system via a broadcast channel. In an embodiment, the communication component 316 further includes a near field communication (NFC) module to facilitate short range communication. For example, the NFC module may be implemented based on Radio Frequency Identification (RFID) technology, Infrared Data Association (IrDA) technology, Ultra Wide Band (UWB) technology, Bluetooth® (BT) technology and other technologies.

In embodiments, the device 300 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for executing the methods described above.

In embodiments, there is further provided a non-transitory computer-readable storage medium including instructions, such as the memory 304 including instructions. The instructions are executable by the processor 320 of the device 300 to accomplish the methods described above. For example, the non-transitory computer-readable storage medium may be a ROM, random access memory (RAM), CD-ROM, magnetic tape, floppy disk, and optical data storage device, among others.

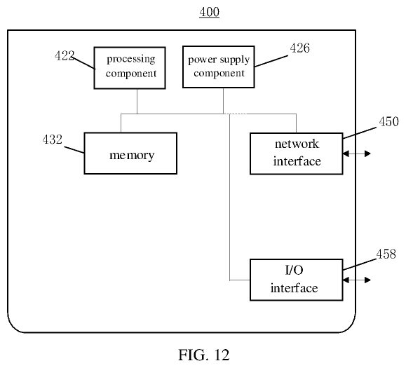

FIG. 12 is a block diagram of a device 400 for random access illustrated according to an embodiment. For example, the device 400 may be provided as a server. Referring to FIG. 12, the device 400 includes a processing component 422, which further includes one or more processors, and a memory resource represented by a memory 432 for storing instructions, such as an application program, that may be executed by the processing component 422. The application program stored in memory 432 may include one or more modules each corresponding to a set of instructions. In addition, the processing component 422 is configured to execute instructions to perform the method described above.

The device 400 may also include a power supply component 426 configured to perform power management of the device 400, a wired or wireless network interface 450 configured to connect the device 400 to a network, and an input/output (I/O) interface 458. The device 400 may operate an operating system stored in the memory 432, such as Windows Server™, Mac OS X™, Unix™, Linux™, FreeBSD™ or the like.

In embodiments, the device 400 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the methods described above.

In embodiments, there is further provided a non-transitory computer-readable storage medium including instructions, such as a memory 432 including instructions, the instructions being executable by a processing component 422 of the device 400 to accomplish the methods described above. For example, the non-transitory computer-readable storage medium may be a ROM, random access memory (RAM), CD-ROM, magnetic tape, floppy disk, and optical data storage device, among others.

It is further understood that “a plurality of” in the present disclosure refers to two or more, and other quantifiers are similar. The term “and/or” describes an association relationship of the associated objects, indicating that three relationships may exist, e.g., A and/or B, which may indicate: A alone, both A and B, and B alone. The character “/” generally indicates an “or” relationship between the related objects before and after the character. The singular forms “a”, “an” and “the” are also intended to include the plural forms, unless the context clearly indicates otherwise.

It is further understood that the terms “first”, “second”, etc. are used to describe various types of information, but that such information should not be limited to these terms. These terms are used only to distinguish the same type of information from one another and do not indicate a particular order or level of importance. In fact, the expressions “first”, “second”, etc. may be used completely interchangeably. For example, without departing from the scope of the present disclosure, the first information may also be referred to as the second information, and similarly, the second information may be referred to as the first information.

It is further to be understood that in the embodiments of the present disclosure, although operations are described in a specific order in the drawings, it should not be construed as requiring that these operations be performed in the specific order shown or in serial order, or that all of the operations shown are performed in order to obtain a desired result. In particular environments, multitasking and parallel processing may be advantageous.

Other embodiments of the present disclosure will readily come to mind to those skilled in the art upon consideration of the specification and practice of the invention disclosed herein. This application is intended to cover any variations, uses, or adaptations of the present disclosure that follow the general principles of the present disclosure and include means of common knowledge or customary skill in the art not disclosed herein. The specification and embodiments are to be regarded as exemplary only, and the true scope and spirit of the present disclosure is indicated by the following claims.

It is to be understood that the present disclosure is not limited to the precise structure that has been described above and illustrated in the accompanying drawings, and that various modifications and changes may be made without departing from its scope. The scope of the present disclosure is limited only by the appended claims.

1. A method for random access, performed by a terminal, comprising:
determining random access resource configuration information, wherein the random access resource configuration information is configured to indicate a plurality of initial uplink bandwidth parts, and wherein each initial uplink bandwidth part of the plurality of initial uplink bandwidth parts comprises a physical random access channel (PRACH) resource; and
performing random access based on the random access resource configuration information.

2. The method of claim 1, wherein the plurality of initial uplink bandwidth parts are provided with different frequency domain positions.

3. The method of claim 2, wherein part of configuration information of the plurality of initial uplink bandwidth parts is the same.

4. The method of claim 1, wherein PRACH resources included in respective initial uplink bandwidth parts of the plurality of initial uplink bandwidth parts are provided with different time domain positions.

5. The method of claim 1, wherein determining the random access resource configuration information comprises at least one of:
determining, based on remaining minimum system information (RMSI), the random access resource configuration information, or
determining, based on a predefined rule, the random access resource configuration information.

6. The method of claim 5, wherein determining the random access resource configuration information based on the RMSI comprises:
determining, in response to determining that part of configuration information of the plurality of initial uplink bandwidth parts is the same, the same configuration information based on the RMSI of a single reception.

7. The method of claim 1, wherein performing random access based on the random access resource configuration information comprises:
selecting a first initial uplink bandwidth part among the plurality of initial uplink bandwidth parts indicated by the random access resource configuration information, and performing the random access on the first initial uplink bandwidth part using a listen before talk random access mechanism.

8. The method of claim 7, wherein selecting the first initial uplink bandwidth part among the plurality of initial uplink bandwidth parts indicated by the random access resource configuration information, comprises:
randomly selecting the first initial uplink bandwidth part among the plurality of initial uplink bandwidth parts indicated by the random access resource configuration information; or
selecting, based on a preset rule, the first initial uplink bandwidth part among the plurality of initial uplink bandwidth parts indicated by the random access resource configuration information.

9. The method of claim 7, further comprising:
in response to determining that a number of failures of the listen before talk mechanism on the first initial uplink bandwidth part is greater than a first number threshold, switching to a second initial uplink bandwidth part to perform the random access using the listen before talk random access mechanism.

10. The method of claim 9, wherein the first number threshold is determined based on time of continuous failures of the listen before talk mechanism, or a number of continuous failures of the listen before talk mechanism.

11. The method of claim 7, further comprising:
in response to determining that a number of failures of the listen before talk mechanism on a same component carrier (CC) is greater than a second number threshold, triggering a high-level processing procedure.

12. A method for random access, performed by a network device, comprising:
determining random access resource configuration information, wherein the random access resource configuration information is configured to indicate a plurality of initial uplink bandwidth parts, and wherein each initial uplink bandwidth part of the plurality of initial uplink bandwidth parts comprises a physical random access channel (PRACH) resource; and
sending the random access resource configuration information.

13. The method of claim 12, wherein the plurality of initial uplink bandwidth parts are provided with different frequency domain positions.

14. The method of claim 13, wherein part of configuration information of the plurality of initial uplink bandwidth parts is the same.

15. The method of claim 12, wherein PRACH resources included in respective initial uplink bandwidth parts of the plurality of initial uplink bandwidth parts are provided with different time domain positions.

16. The method of claim 12, wherein sending the random access resource configuration information comprises:
sending, based on remaining minimum system information (RMSI), the random access resource configuration information.

17. The method of claim 16, wherein sending the random access resource configuration information based on the RMSI comprises:
sending, in response to determining that part of configuration information of the plurality of initial uplink bandwidth parts is the same, the same configuration information based on a single transmission of the RMSI.

18. (canceled)

19. (canceled)

20. A device for random access, comprising:
a processor; and
a memory configured to store instructions executable by the processor;
wherein the processor is configured to:
determine random access resource configuration information, wherein the random access resource configuration information is configured to indicate a plurality of initial uplink bandwidth parts, and wherein each initial uplink bandwidth part of the plurality of initial uplink bandwidth parts comprises a physical random access channel (PRACH) resource; and
perform random access based on the random access resource configuration information.

21. A device for random access, comprising:
a processor; and
a memory configured to store instructions executable by the processor;
wherein the processor is configured to perform the method of claim 12.

22. A non-transitory storage medium, storing instructions that, when executed by a processor of a terminal, cause the terminal to perform the random access method of claim 1.

23. (canceled)
